(19) United States
(12) Patent Application Publication
(10) Pub. No.: US 2026/0252029 A1
(43) Pub. Date: Aug. 27, 2026

(54) MASTER PLATE FOR HOLOGRAM REPLICATION

(71) Applicant: Carl Zeiss Jena GmbH, Jena (DE)

(72) Inventors: Stefan SCHWEDAT, Jena (DE); Nadin BRUENNER, Grossheringen (DE); Jeanette STAMMER, Jena (DE); Justyna ZDZIAREK, Erfurt (DE); Lisa ACKERMANN, Jena (DE)

(21) Appl. No.: 18/878,058

(22) PCT Filed: Jun. 20, 2023
(86) PCT No.: PCT/EP2023/066661

§ 371 Date: Dec. 22, 2024

(30) Foreign Application Priority Data
Jun. 22, 2022 (DE) 10 2022 206 277.9

(51) Int. Cl. G03H 1/02; B32B 7/12; B32B 17/10

(52) U.S. Cl. CPC G03H 1/0276; B32B 7/12; B32B 17/10; B32B 2250/03; B32B 2307/40; G03H 2001/0296; G03H 2260/12

(57) ABSTRACT

A master plate for industrial hologram replication can include a flat and planar composite pane having a thick glass pane as a carrier for minimizing the deflection of the master plate and a thin glass pane for protecting a master hologram layer from mechanical influences, and at least one master hologram layer extending between the glass panes which has the optical function of a hologram. The thick glass pane can have a thickness perpendicular to the planar extent of greater than two millimeters. The thin glass pane can have has a thickness perpendicular to the planar extent of between two millimeters and 0.1 millimeters. An unevenness of the composite pane is preferably less than 0.03% of a length of a direction of extent of the surface of the planar composite pane. Also provided is a method for producing a master plate.

### PRIORITY

This application claims the priority of German patent application DE 10 2022 206 277.9, filed Jun. 22, 2022, which is hereby incorporated herein by reference in its entirety.

### FIELD

The invention relates, in a first aspect, to a master plate for industrial hologram replication, comprising a flat and two-dimensional composite pane having a thick glass pane as carrier for minimization of bending of the master plate and a thin glass pane for protection of a master hologram layer from mechanical influences, and at least one master hologram layer between the glass panes that assumes the optical function of a hologram, wherein the thick glass pane has a thickness at right angles to the areal extent of greater than 2 millimeters, wherein the thin glass pane has a thickness at right angles to the areal extent of between 2 millimeters and 0.1 millimeter, and wherein any unevenness of the composite pane is preferably less than 0.03% of a length of a direction of extension of the area of the two-dimensional composite pane.

In a second aspect, the invention relates to a production method for a master plate.

### BACKGROUND

Technical holograms, by various holography methods, can be directly recorded or printed from computer-generated data with the aid of wavefront printers. However, these production methods are unsuitable for mass production of demanding optical functions because they are time-consuming. There are suitable replication methods for this purpose.

An important replication method for holograms corresponds to the technically known method of contact copying. This involves applying a second photosensitive material directly to what is called the master hologram. By simultaneous exposure of the photosensitive material and the master hologram with sufficiently coherent light, the optical function of the master is transferred to the second photosensitive material in the form of a hologram, creating a copy of the master hologram.

Such a method is described, for example, in DE 19809503 A1 and in WO 2008145077 A1.

In EP 0919961 B1, a surface relief is used as master for the creation of a security hologram.

In order to make this process capable of mass production, the master hologram has to be protected against mechanical influences. The easiest way of achieving this is when the master hologram is embedded between glass plates (quartz glass, float glass, sodium silicate glass or the like). The optical quality of the holograms produced by the copying is dependent to a significant degree on the distance (optical path length) between master hologram and the second photosensitive material; the smaller the distance, the more exact the optical function of the master hologram. In the case of a distance of zero, the optical functions are identical. As the distance increases, the angle spectrum of the copied optical function is reduced, among other effects.

JP 2006349874 A describes a master stack having two transmission holograms that are laminated onto a glass substrate.

In U.S. Pat. No. 6,097,514 too, at least one photosensitive material is applied to a glass substrate.

For the copying process to be capable of mass production and automated, the master holograms must be integrated between sufficiently large-format glass panes, where the glass composites with the internal master holograms advantageously meet the following conditions:
1. Minimum bending throughout the copying process (advantageously less than 500 μm per meter of edge length of the glass panes).
2. Minimum corrugation on the glass surface.
3. Fluctuation in thickness of not more than 2% (advantageously less than 250 μm per meter of edge length of the glass panes).
4. No trapped air or particles visible to the naked eye in the hologram region.

These requirements are not met, especially for pane formats over and above an area of 0.25 up to about 2 m² during the production process, by any known reliable and practicable methods in the prior art, nor by any master holograms.

### SUMMARY

It is an object of the invention to provide a master hologram and a method of producing a master hologram without the disadvantages of the prior art. Provided herein is a master plate and a particularly reliable, efficient and inexpensive production method for such a master plate, wherein the master plate enables a particularly reliable and faultless hologram copy and is suitable for the production of particularly high-quality holograms that can have an optical function with a large angle spectrum.

In a first aspect, provided is a master plate for industrial hologram replication, comprising a flat and two-dimensional composite pane having a thick glass pane as carrier for minimization of bending of the master plate and a thin glass pane for protection of a master hologram layer from mechanical influences, and at least one master hologram layer between the glass panes that includes, and/or is capable of including, the optical function of a hologram. The master plate is characterized in that the thick glass pane has a thickness at right angles to the areal extent of greater than 2 millimeters, the thin glass pane has a thickness at right angles to the areal extent of between 2 millimeters and 0.1 millimeter, and any unevenness of the composite pane is preferably less than 0.03% of a length of a direction of extension of the area of the two-dimensional composite pane.

Industrial hologram replication preferably includes hologram replication in industrial mass production.

A composite pane preferably comprises at least two glass panes and at least one interlayer.

What is meant here by “two-dimensional” is forming a broader area, in a flattened-out manner and/or extending over an area. For example, “two-dimensional” may mean that the pane has a large extent along one plane or surface and a comparatively significantly smaller extent in a direction perpendicular thereto. A significantly smaller extent preferably means an extent smaller than the smallest extent along the surface or plane by at least a factor of two.

The master hologram layer may preferably be encompassed by a first layer having a homogeneous thickness.

The master hologram layer may include the optical function of a hologram. However, it may also be the case that the master hologram layer is merely capable of having or including the optical function of a hologram. For example, the master hologram layer may comprise photopolymers that enable exposure of the optical function by a (later) exposure process.

The length of a direction of extent of the area is preferably a length along the area of the composite pane in any direction. This is preferably a straight line. In the case of a rectangle, this may be, for example, an edge length or a diagonal.

Because of material inhomogeneities and imperfect processing, for example, the composite pane, preferably a surface of the composite pane, may have at least one region in which the shape has at least one variance from a flat shape. This may be manifested, for example, as an elevation and/or depression. Unevenness refers here to the maximum vertical distance (at right angles to the areal extent) between the lowest and highest points. This shall in particular be less than 0.03% of any length of a direction of extension of the composite pane. If, for example, the longest extent thereof along the area is one meter, this distance is advantageously less than 300 μm.

The person skilled in the art knows how the unevenness can be kept correspondingly small, for example by selection of appropriate glass panes.

Such a master plate is mechanically stable and protected against bending. At the same time, the optical distance between master hologram and replication to be produced is kept short. It is thus possible both to maintain high quality of the replication copy and to improve ease of handling of the master.

In a preferred embodiment, a fluctuation in thickness of the composite pane is less than 0.5% of the maximum thickness at right angles to the areal extent of the composite pane. In this way, the composite pane can be kept particularly flat.

In a further preferred embodiment, the thin glass pane has a thickness at right angles to the areal extent of less than 1 millimeter, especially less than 0.5 millimeter. This increases the optical quality of the replication.

In a further preferred embodiment, the unevenness of the composite pane is less than 0.03% of the length of any direction of extension of the area of the two-dimensional composite pane divided by the number of uneven sites in the area. If, for example, the longest extent thereof across the area is one meter and there are 3 uneven sites distributed over the composite pane area, this vertical distance or the unevenness is advantageously smaller than 100 μm. It has been found that the unevenness in this embodiment ensures particularly advantageous properties in the copying process.

In a further preferred embodiment, the master hologram layer has a thickness between 1 μm and 200 μm, preferably between 5 μm and 50 μm. Such a master hologram layer is capable of incorporating even complex optical functions.

In a further preferred embodiment, the length of a direction of extension of the area of the two-dimensional composite pane includes a width of the composite pane of at least 50 cm.

In a further preferred embodiment, the two-dimensional composite pane has a width of at least 50 cm.

In a further preferred embodiment, the thick glass pane has a thickness between 2 mm and 50 mm, preferably between 2 mm and 20 mm. This thickness has been found to be ideal for mechanical stability coupled with not too high a weight of the master plate.

In a further preferred embodiment, the composite pane has an areal extent having an area between 0.25 m² and 3 m².

In a further preferred embodiment, the composite pane further comprises a transparent, double-sidedly adhesive film, a carrier film for the master hologram layer and/or at least one layer of an adhesive. This embodiment is described in detail below in relation to production of the master hologram.

In a further preferred embodiment, a thickness of the adhesive layer is between 10 μm and 500 μm, preferably 100 μm to 200 μm.

In a further preferred embodiment, the carrier film for the master hologram layer comprises a material selected from the group of polycarbonate, cellulose acetate derivatives, polyamides, polyethylene terephthalate, polyvinylacetate/ethylene-vinyl acetate copolymers and/or cycloolefins, and preferably has a thickness between 25 μm and 250 μm. These materials have advantageous mechanical and optical properties. This embodiment is described in detail below in relation to production of the master hologram.

In a further preferred embodiment, the transparent double-sidedly adhesive film has a thickness between 10 μm and 90 μm, preferably of 50 μm.

In a further preferred embodiment, the adhesive comprises a solvent-free epoxide-, acrylate-, urethane- and/or silicone-based multicomponent system.

In a further preferred embodiment, the master hologram layer points a photopolymer comprises that especially has intrinsic absorption of visible light of less than 8%. The person skilled in the art knows how intrinsic absorption can be measured, calculated and/or determined. This results in improved optical properties.

In a further preferred embodiment, a haze value of the composite pane transverse to the areal extent is less than 5%. The person skilled in the art knows how the haze value can be measured, calculated and/or determined. This results in improved optical properties.

Also provided is a production method for a master plate comprising a flat and two-dimensional composite pane, preferably as described above, comprising:
applying a first layer of homogeneous thickness that comprises at least one master hologram layer on a first side of a two-dimensional thin glass pane, where an outer region at the lateral edges of the thin glass pane remains free of the first layer, where the master hologram layer is capable of having an optical function of a hologram,
applying spacer elements to the first side in the outer region, where the spacer elements are set up to keep the outer edges and/or lateral edges of a two-dimensional thick glass pane to be applied and of the thin glass pane at a predefined separation in the production method,
applying the thick glass pane by superimposition onto the first side of the thin glass pane with an intervening adhesive layer, where the thick glass pane has the same areal dimensions as the thin glass pane,
introducing the two glass panes into an arrangement comprising a vacuum module and a vibration module, where the arrangement is set up for mutual contact pressure of the glass panes and uniform distribution of the adhesive in the desired thickness by generation of reduced pressure and vibrations, preferably maintaining unevenness of external faces of the glass panes of less than 0.03% of a length along the areal extent of the glass panes,
curing the adhesive.

It is evident to a person skilled in the art that advantages, definitions, and embodiments of the device according to the invention likewise apply to such method.

The person skilled in the art will see that the step of “applying a first layer of homogeneous thickness that comprises at least one master hologram layer on a first side of a two-dimensional thin glass pane, where an outer region at the lateral edges of the thin glass pane remains free of the first layer, where the master hologram layer is capable of having an optical function of a hologram” preferably comprises the provision, for example the prior provision, of a two-dimensional thin glass pane.

What is preferably meant by the master hologram layer being capable of having an optical function of a hologram is that it comprises a corresponding material that either already has refractive index modulation corresponding to the optical function or else that this optical function can be introduced into the master hologram layer by a corresponding process, for example an exposure, for example at a later juncture.

The spacer elements applied are preferably spaced apart from one another.

The spacer elements advantageously keep the two-dimensional thick glass pane and the thin glass pane at a predefined distance in the production process. In this way, it is especially possible to enable an essentially full-area adhesive layer in the desired thickness between the glass panes. The predefined distance is preferably chosen such that an adhesive layer in the desired thickness can be achieved. An adhesive layer in the desired thickness is advantageously suitable for influencing mechanical properties, for example mechanical stability, bending and/or elasticity, in a desired manner.

The two-dimensional thick glass pane and the two-dimensional thin glass pane preferably have the same dimensions in the area at right angles to the thickness.

The person skilled in the art will see that the step of “applying the thick glass pane by superimposition onto the first side of the thin glass pane with an intervening adhesive layer, where the thick glass pane has the same areal dimensions as the thin glass pane” preferably comprises the applying of an adhesive layer, especially to the first layer and the outer region, especially prior to application of the thick glass pane.

Preference is given to maintaining unevenness of external faces of the glass panes of less than 0.03% of a length along the areal extent of the glass panes. The person skilled in the art knows how unevenness can be kept correspondingly small by use of corresponding manufacturing tolerances, especially in the glass panes, but advantageously also in the spacer elements. Use of the arrangement can additionally ensure, in an advantageous manner, that the unevenness of the thin and thick glass panes is maintained even in the production of the composite pane, in particular by preventing any stresses by use of vibrations.

This advantageously likewise results in uniform distribution of the adhesive. The desired thickness corresponds in particular to the space between the pane and a layer and/or between the panes which is defined by the above-defined distance.

In particular, it is possible by addition of the adhesive for the intermediate adhesive layer in the desired amount in conjunction with the use of the modules of the arrangement and the spacer elements to achieve an adhesive layer having suitable properties.

In a preferred embodiment, the master hologram layer is applied essentially over the full area as a liquid material.

The liquid material may preferably be converted to a solid or firmer state at a later juncture, preferably prior to or during exposure or on fixing, for example by suitable exposure, for example by UV light.

The liquid material is especially a liquid photopolymer.

In a preferred embodiment, the liquid photopolymer comprises
(i) at least one writing monomer;
(ii) a photoinitiator system; and
(iii) at least one organic component,
where the liquid photopolymer optionally further comprises one or more of the following components: a catalyst, a dye, a radical stabilizer, a solvent, a non-polymerizable component, a reactive diluent, a dye oxidant, a dye reductant, a bleach, a thixotropic agent, a nucleating agent and/or auxiliaries or additives.

Suitable liquid photopolymers are known to the person skilled in the art. For example, compositions for liquid photopolymers as disclosed in EP1779196B1 are suitable. In a preferred embodiment, the liquid photopolymer is binder-free. The writing monomer is preferably an ethylenically unsaturated monomer having the general formula:

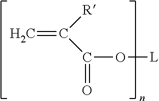

where n is 2 to 4, R′ is hydrogen or CH₃ and L is

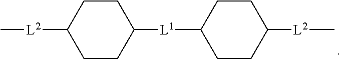

where the phenyl rings are optionally substituted by one or more substituents selected from the group consisting of halogen, C₁₋₄-alkyl, alkoxy or hydroxy;
L¹ is a covalent bond of a straight chain or branched C₁₋₄-alkyl group;
L² is a covalent bond, a straight chain or branched C₁₋₄-alkyl group which is optionally hydroxy-substituted, or —[L³-O]ₘ— where L³ is a C₁₋₄-alkylene group and m is 1 to 40;
where the at least one organic component is selected from the group consisting of castor oil, palm kernel oil, coconut oil and combinations thereof.

In a further preferred embodiment, the application of the first layer is preceded by first applying an optically transparent, double-sidedly adhesive film essentially to the full area of the first side of the thin glass pane, preferably leaving at least some areas of the outer region at the lateral edges free of the film.

The optically transparent, double-sidedly adhesive film may also be referred to as, or may comprise, an OCA (optically clear adhesive). The optically transparent, double-sidedly adhesive film is preferably matched in terms of its refractive index to the thin and/or thick glass pane in order to avoid later reflections in the master plate.

The optically transparent, double-sidedly adhesive film can improve the adhesion of the first layer in an efficient and simple manner.

The outer region that remains free of film at least in some areas may then be utilized, for example, in order to position the spacers there.

In a further preferred embodiment, the spacer elements are applied to the optically transparent, double-sidedly adhesive film in the areas of the outer region that do not remain clear.

This makes the applying of the spacer elements particularly efficient.

In a further preferred embodiment, the spacer elements are adhesive-bonded in the outer region of the thin glass pane, preferably with a fast-curing and/or mobile adhesive, especially with superglue and/or UV adhesive.

It is thus possible to apply the spacer elements in a particularly robust manner.

In a further preferred embodiment, the first layer comprises the master hologram layer which is disposed in a middle region spaced apart from the lateral edges of the thin glass pane and comprises a compensation layer having the same thickness as the master hologram layer in an edge region between outer region and master hologram layer that remains free of the master hologram.

Advantageously, the compensation layer may comprise the same composition or the same material as the master hologram layer described herein, i.e., for example, an (initially liquid) photopolymer or a photopolymer and a carrier film.

The first layer thus preferably comprises two compositions, firstly the master hologram layer and secondly the compensation layer, but these preferably directly adjoin one another and hence form a homogeneous first layer. In this way, the expansion of the master hologram layer can be precisely adjusted, and resources are conserved. Frequently, it is particularly advantageous to position the master hologram layer to be exposed more in the middle region and to leave a gap from the outer edges, in order, for example, to position holding elements to hold the master plate in the outer region in the replication process.

In a further preferred embodiment, the master hologram layer comprises a carrier film, where the master hologram layer preferably already has the optical function prior to application.

The carrier film may, for example, comprise plastic or another substrate material and be capable of imparting greater mechanical stability and/or other desired properties to the master hologram layer.

The carrier film is preferably optically transparent. Preference is given to using a polycarbonate material, although it is also possible to use a multitude of other materials as disclosed in detail herein.

The carrier film preferably comprises one or more of the following materials: polycarbonate (PC), polyethylene terephthalate (PET), polybutylene terephthalate, polyethylene, polypropylene, cellulose acetate, triacetate (TAC), cellulose hydrate, cellulose nitrate, cycloolefin polymers, polystyrene, polyepoxides, polysulfone, cellulose triacetate (CTA), polyamide, polymethylmethacrylate, polyvinylchloride, polyvinylbutyral or polydicyclopentadiene or mixtures thereof.

The carrier film may be present either on a side of the master hologram layer facing the thin glass pane or on a side remote from the thin glass pane.

In a further preferred embodiment, the compensation layer comprises a film.

The film may preferably include the same materials and/or comprise material properties like the carrier film.

A compensation layer comprising a film can advantageously simplify the production method.

In a further preferred embodiment, the compensation layer and/or the optically transparent, double-sidedly adhesive film is first applied to a complete edge region and then is removed again in the outer region.

This may be found to be a particularly simple production method in many versions.

In a further preferred embodiment, the compensation layer is applied after the master hologram layer, wherein the compensation layer is also applied to the master hologram layer and then is removed there again.

This is the most efficient method of applying compensation layer for many embodiments.

In a further preferred embodiment, a step of removing part of the compensation layer and/or of the optically transparent, double-sidedly adhesive film comprises the following step:
severing the compensation layer and/or the optically transparent, double-sidedly adhesive film between the part to be removed and the remaining part, preferably by laser cutting,
lifting off the part of the compensation layer and/or of the optically transparent, double sidedly adhesive film that is to be removed.

It is surprisingly possible here, by precise severing of the compensation layer, to achieve a homogeneous first layer by means of an outer compensation layer and the inner master hologram layer. It is thus possible to bond compensation layer and master hologram layer in an advantageously virtually seamless manner, as a result of which it is advantageously impossible to transfer the “binding seam” as unevenness to the thinner glass plate.

In a further preferred embodiment, the thin glass pane has a thickness at right angles to the areal extent of between 2 millimeters and 0.1 millimeter, wherein the thick glass pane has a thickness at right angles to the areal extent of between 2 millimeters and 20 mm.

It has been found that this combination of thicknesses enables an optimal combination of suitable optical properties of the master hologram and stable mechanical properties of the composite pane. Advantageously, it is thus also possible to achieve a desired flatness of the composite pane.

In a further preferred embodiment, the applying of the thick glass pane by superimposition onto the thin glass pane with an intervening adhesive layer comprises the following steps:
applying an adhesive at least to some areas of the at least one layer of the thin glass pane
positioning the thick glass pane by superimposition above the thin glass pane, with contact between thick and thin glass panes and/or between the thick glass pane and the spacer elements at one lateral edge, forming a wedge-shaped gap between the glass plates
lowering the remaining portion of the thick glass pane onto the thin glass pane with constantly decreasing gap size.

These steps can achieve particularly precise application of the thick glass pane, in which a particularly low level of mechanical stresses and/or shear forces is advantageously introduced.

In a further preferred embodiment, for the positioning and lowering, stops are used on a rest for the glass panes, which are set up to prevent lateral movement of the glass plates and to enable stepwise lowering of the thick glass plate.

A rest is preferably a flat and mechanically stable surface on which the elements of the composite pane are processed as described herein.

In a further preferred embodiment, a desired thickness of the adhesive layer is between 10 μm and 500 μm, preferably 100 μm to 200 μm.

In a further preferred embodiment, the arrangement comprises a vacuum press having an elastic and airtight membrane cover that can be arranged above the glass panes, and the rest, wherein the introduction into the arrangement comprises the following steps:
applying the air-tight elastic membrane cover to the glass panes and the rest, so as to form a closed cavity between rest and membrane cover that encloses the glass panes,
generating a reduced pressure within the cavity with an air pressure of less than 100 mbar, preferably less than 25 mbar, such that the thick glass pane is pressed onto the thin glass pane by the membrane and the preferably adhesive is distributed uniformly.

The membrane may comprise a mobile and/or elastic substance, for example a rubber. Thus, the process of applying itself advantageously does not transmit any great force to the glass panes, and pressing-on takes place essentially only by generation of reduced pressure.

The reduced pressure would allow edge regions into which the adhesive has not yet run fully to be more highly compressed than the regions in which adhesive is already present. The spacers advantageously prevent the glass edges from being pressed together. For instance, it is possible by a combination of reduced pressure and spacers to produce a homogeneous adhesive layer and hence a particularly flat composite pane.

In a further preferred embodiment, the reduced pressure is switched on at a time between a tenth of the pot life of the adhesive and a quarter of the pot life of the adhesive and is switched off on attainment of the pot life of the adhesive.

The vibrations are preferably applied directly after the application of the thick glass pane. What is meant here more particularly by “directly” is essentially after the time interval for making the production steps required for the purpose has ended. For example, the composite pane first has to be introduced into the arrangement.

The permanent application of vibrations in particular, in conjunction with a reduced pressure which is not employed permanently, especially not until the adhesive has cured, can thus advantageously establish a homogeneous adhesive layer and/or a flat composite pane. If, for example, the reduced pressure should compress the middle part of the panes to too high a degree, this is advantageously delayed when the reduced pressure is established in good time, i.e. preferably before the adhesive reaches a certain strength. It is possible here, for example, to suck cement that has been expressed from the adhesive gap in the middle region back into the gap, which results in quite a uniform adhesive layer thickness. Advantageously, this process is assisted by the agitation or vibrations.

In a further preferred embodiment, the reduced pressure is switched on at a time between a tenth of the pot life of the adhesive and a quarter of the pot life of the adhesive and is switched off on attainment of twice the pot life of the adhesive.

Even though distinct solid-state characteristics of the adhesive are manifested with attainment of the pot life, waiting for twice the pot life surprisingly prevents opening of the adhesive gap and drawing of air bubbles, for example, in a much better manner. This may otherwise be the case especially when very stiff glass panes are used.

In a further preferred embodiment, the vibrations have a frequency between 50 Hz and 20 KHz and are preferably varied over time, where the vibrations are preferably employed until the adhesive has cured.

It has been found that this allows the adhesive to be distributed particularly uniformly and/or any stresses within the composite pane to be released.

In a further preferred embodiment, the curing is assisted by supply of heat.

It is thus possible to individually control and/or accelerate the curing process.

In a further preferred embodiment, after the adhesive has cured, mechanical removal of adhesive residues at the lateral faces of the resultant composite pane is included, preferably by a grinding process.

In a further preferred embodiment, the rest used is a mechanically stiff and flat workplate having at least one face like the glass panes, which is preferably set up to have not more than 1/10 of the bending of the thick glass pane at the same stress.

What is preferably meant by the workplate having not more than 1/10 of the bending of the thick glass pane at the same stress is that the workplate, under a force acting thereon, which acts in the middle, for example, and is directed at right angles to the areal extent, bends by not more than 1/10 of the extent to which the thick glass pane bends under an equal force acting in the same way. It is preferably assumed here that the workplate or glass pane lies on the edges (or is otherwise secured at an essentially fixed location at the edges) and hence an opposing counter-force to the bending force is exerted at the edges. What is preferably meant here by bending is the offset against an unstressed workplate or glass pane. It has been found that, when such a workplate is used, it is possible to achieve a particularly flat composite pane that advantageously has the aforementioned preferred unevenness.

In a further preferred embodiment, the rest used is a mechanically stiff and flat workplate having unevenness of less than 50 μm per meter of edge length of the workplate, preferably a breadboard having an internal honeycomb structure or a granite stoneware board having a thickness of at least 10 cm, where the edge length of the workplate in each direction is preferably at least 100 mm greater than the extent of the glass panes in that direction.

What is meant, for example, by unevenness of less than 50 μm per meter of edge length is that unevenness is less than 100 μm in the case of an edge length of 2 m. Unevenness of 50 μm can thus be assumed to be a constant factor that has to be multiplied by the actual edge length in order to calculate the limiting unevenness for the workplate.

When a breadboard is used, it may be advantageous to cover any holes in the breadboard by application of a further glass plate.

It has been found that, when such a workplate is used, it is possible to achieve a particularly flat composite pane that advantageously has the aforementioned preferred unevenness.

In a further preferred embodiment, the production method further comprises exposing of the optical function onto the master hologram layer, preferably after the adhesive has cured.

What is preferably meant by the exposing of the optical function is that the optical property to be replicated from the master plate is first exposed into the master hologram itself. It is preferably possible here to use a coherent optical light source. In order to create the optical properties for the exposure, it is possible to use methods known to the person skilled in the art. “Exposure onto” and “exposure into” should preferably be regarded as synonyms.

In a further preferred embodiment, a further adhesive layer is introduced, preferably set up to compensate for various thermal stresses in the encompassed plates and/or layers, where the adhesive layer especially comprises polyvinyl-butyl acetate, polyvinyl-ethyl acetate and/or RTV (room temperature-crosslinking) silicone.

These materials have been found to be particularly suitable for compensation of thermal stresses.

In a further preferred embodiment, the master hologram layer comprises a photopolymer.

This may comprise the aforementioned liquid photopolymers or other non-liquid photopolymers, for example photosensitive materials known to the person skilled in the art. Examples here include the photopolymers used in “Bayfoil” from Covestro or dichromated gelatin, which is preferably applied from solution but solidifies after the solvent has evaporated.

In a further aspect, the invention relates to a master plate produced by a production method as described above.

It will be apparent to the person skilled in the art that advantages, definitions and embodiments of the method of the invention and of the apparatus of the invention according to the first aspect are likewise applicable to the apparatus of the invention as claimed above and hereinafter.

### BRIEF DESCRIPTION OF THE DRAWINGS

The invention will be elucidated hereinafter with reference to further figures and examples. The examples and figures serve to illustrate preferred embodiments of the invention without limitation.

FIG. 1 shows the master plate for industrial hologram replication.

FIG. 2 shows the master plate during a production step from the side.

FIG. 3 shows the master plate during a production step from above.

FIG. 4 shows the master plate laterally during the production after the application of spacer elements.

FIG. 5 shows the master plate during the same production step from above.

FIG. 6 shows the master plate laterally during the production after the application of the thick glass pane by superimposition.

FIG. 7 shows the master plate from the side after introduction into the arrangement comprising a vacuum module and a vibration module.

FIG. 8 shows the master plate from the top during production, where the thin glass pane already has the first layer.

FIG. 9 shows the same embodiment in a lateral view.

FIG. 10 shows the master plate that has already been partly produced laterally in one variant of the production method.

FIG. 11 shows the master plate that has already been partly produced laterally in the step of removing the compensation layer.

FIG. 12 shows the master plate laterally, where only the master hologram layer has been applied to the thin glass pane.

FIG. 13 shows the master plate laterally, where the compensation layer has now been applied in one embodiment.

FIG. 14 shows the master plate laterally, where a laser cutting device is used to separate off the portion of the compensation layer.

FIG. 15 shows the master plate laterally, where the compensation layer has been removed again above the master hologram layer.

FIG. 16 shows the preferred steps of the production process.

### DETAILED DESCRIPTION

FIG. 1 shows the master plate for industrial hologram replication, comprising a flat and two-dimensional composite pane having a thick glass pane 6 and a thin glass pane 1, and an intervening master hologram layer 8. The master plate has the properties according to the description, which means that it is mechanically stable and enables replication of high optical quality.

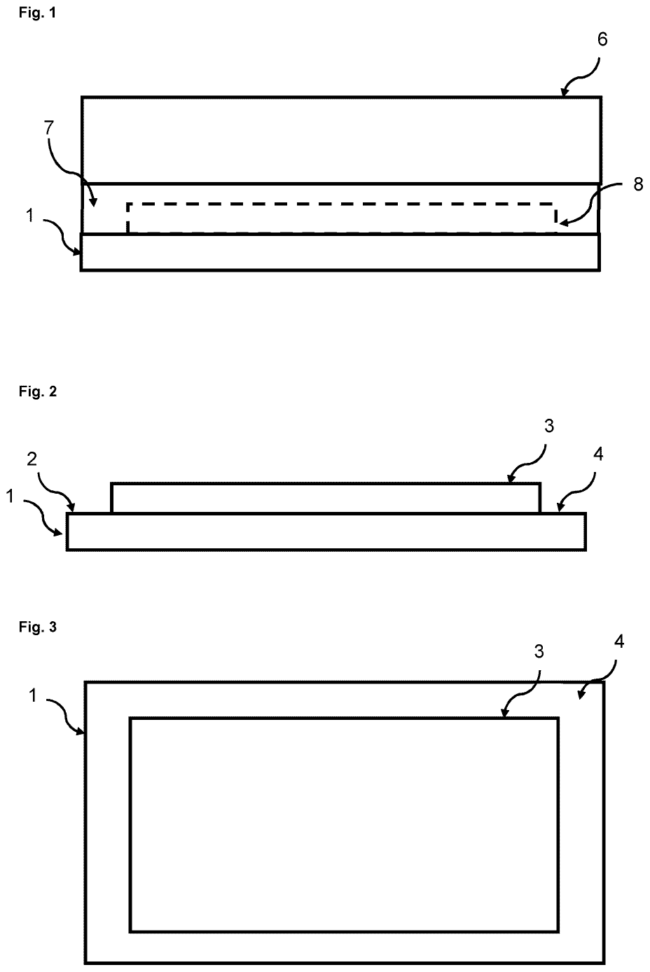

FIG. 2 shows a master plate laterally during production, where a first homogeneous layer 3 comprising at least one master hologram layer has already been applied to a first side 2 of a two-dimensional thin glass pane 1. The outer region 4 at the lateral edges of the thin glass pane 1 remains free of the first layer here.

FIG. 3 shows the master plate during the same production step from the top, with the first side 2 at the top. In this case, the clear outer region 4 that fully surrounds the first layer 3 is readily apparent.

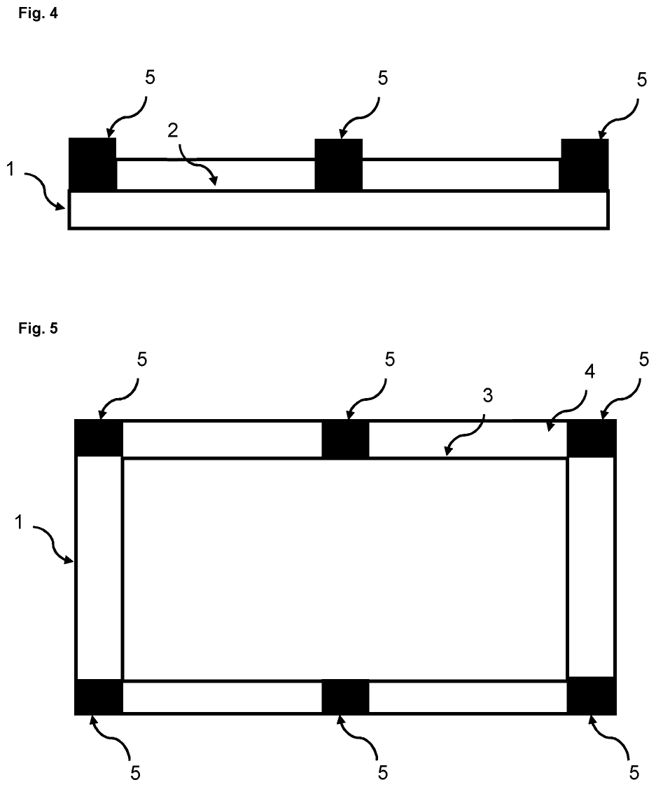

FIG. 4 shows the master plate laterally during the production after the applying of spacer elements 5 to the first side 2 of the thin glass pane 1 in the outer region 4. These spacer elements 5 project a little beyond the first layer 3, in order that they are capable of holding the thick glass pane to be applied at a predefined distance from the thin glass pane 1.

FIG. 5 shows the master plate during the same production step from above. The spacer elements 5 shown in the outer region 4 are spaced apart from one another and distributed uniformly over the outer region to some degree. In the present case, these are applied at the corners of the thin glass pane 1 and likewise in the middle along the long edges of the thin glass pane. However, the distances, number and position of the spacer elements 5 may vary.

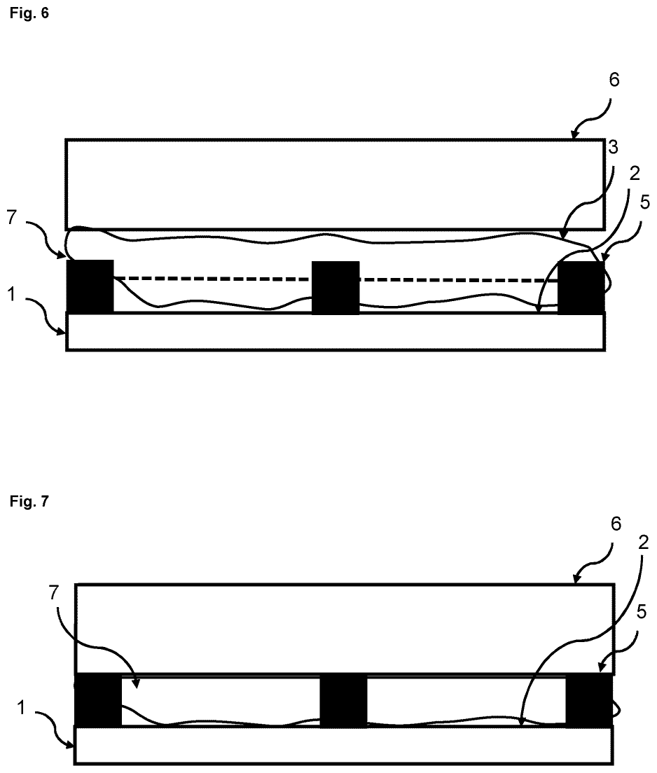

FIG. 6 shows the master plate laterally during the production after the applying of thick glass pane 6 by superimposition onto the first side 2 of the thin glass pane 1 with an intervening adhesive layer 7. The adhesive layer 7 in this step is not yet established and cured in its shape, and the distance between thin glass pane 1 and thick glass pane 6 is not yet ultimately defined. The spacer elements 5 still do not contribute to fixing of the distance. The dotted line shows the first layer 3 which is predominantly covered laterally by the adhesive layer 7 in the outer region.

FIG. 7 shows the master plate from the side after introduction into the arrangement comprising a vacuum module and a vibration module. By generation of reduced pressure and vibrations of the arrangement, the thick glass pane 6 and the thin glass pane 1 are pressed against one another, and the adhesive in the adhesive layer 7 is distributed uniformly in the desired thickness. For this purpose, the arrangement may comprise a vacuum press for example. This may have, for example, an elastic and air-tight membrane lid which is arrangeable above the glass panes, and a rest for the glass panes. Applying the air-tight elastic membrane cover to the glass panes and the rest forms a closed cavity between rest and membrane cover that encloses the glass panes. When the vacuum is switched on, the lid is pressed on and hence presses the thick glass pane 6 and the thin glass pane 1 against one another. The rest can be put under vibrations, which especially assist the process of uniform distribution of the adhesive for a homogeneous adhesive layer 7. The remaining inhomogeneous distribution of the adhesive layer 7, which is still visible in FIG. 7 in the outer region in the lower part of the figure toward the first side 2 of the thin glass pane, is harmless and can advantageously likewise be eliminated by adjustment of the reduced pressure applied and vibrations, such that the adhesive layer 7 there is also homogeneous and “smooth” (not shown). The first layer which is covered laterally in the outer region is not shown here (by contrast with FIG. 6).

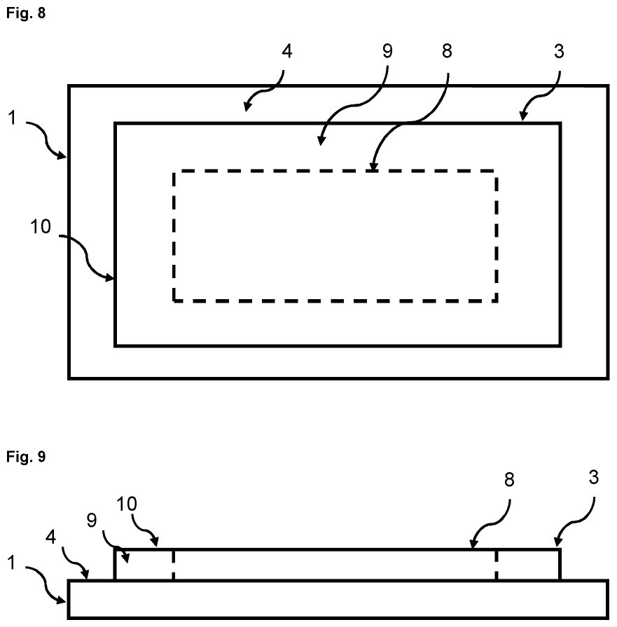

FIG. 8 shows the master plate from the top during production, where the thin glass pane 1 already has the first layer 3. In this embodiment, the first layer 3 comprises the master hologram layer 8 disposed in a middle region spaced apart from the lateral edges of the thin glass pane. In an edge region 9, which remains free of the master hologram, between outer region 4 and master hologram layer 8, a compensation layer 10 having the same thickness as the master hologram layer 8 is included, such that the first layer 3 has a homogeneous thickness overall.

FIG. 9 shows this embodiment in a lateral view. The same thickness of the compensation layer 10 and of the master hologram layer 8 is readily apparent.

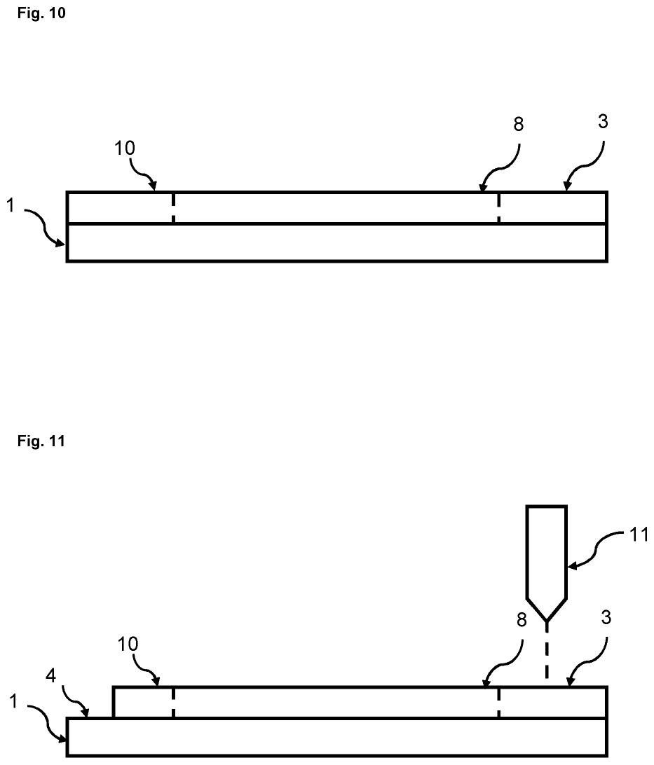

FIG. 10 shows the already partly produced master plate laterally in one variant of the production process, in which a compensation layer 10 is included, where the compensation layer 10 is first applied to the thin glass pane 1 in a complete edge region.

FIG. 11 shows the already partly produced master plate laterally in the step of removing the compensation layer 10 from FIG. 9 in the outer region 4 by means of a laser cutting device 11. On the left-hand side, the compensation layer 10 has already been removed in the outer region 4.

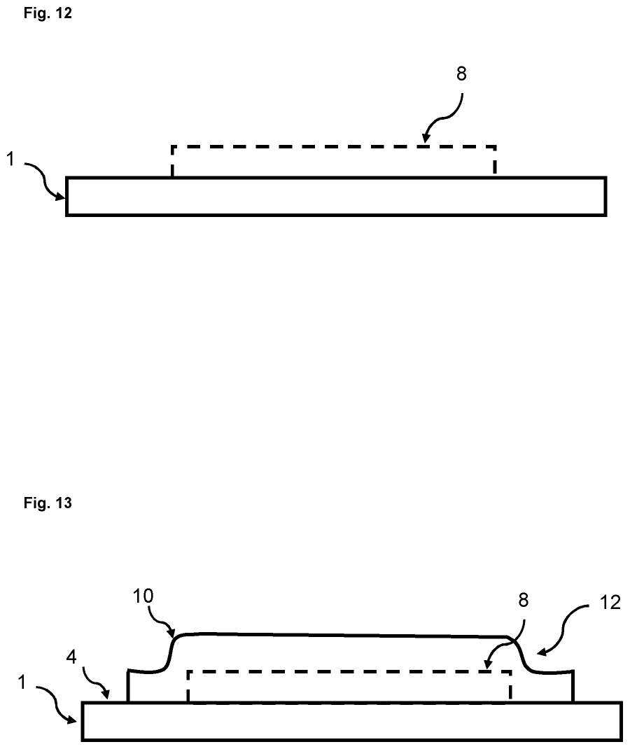

FIG. 12-FIG. 15 describe the production method according to the embodiment in which the compensation layer 10 is applied after the master hologram layer 8, wherein the compensation layer 10 is also applied to the master hologram layer 8 and then is removed there again.

FIG. 12 shows the master plate laterally where, at first, only the master hologram layer 8 has been applied to the thin glass pane 1.

FIG. 13 shows the master plate laterally, where the compensation layer 10 has now been applied to the edge region 9 that remains free of the master hologram between outer region 4 and master hologram layer 8 and to the master hologram layer 8 itself. Thus, the thickness of the resultant layer 12 is inhomogeneous overall.

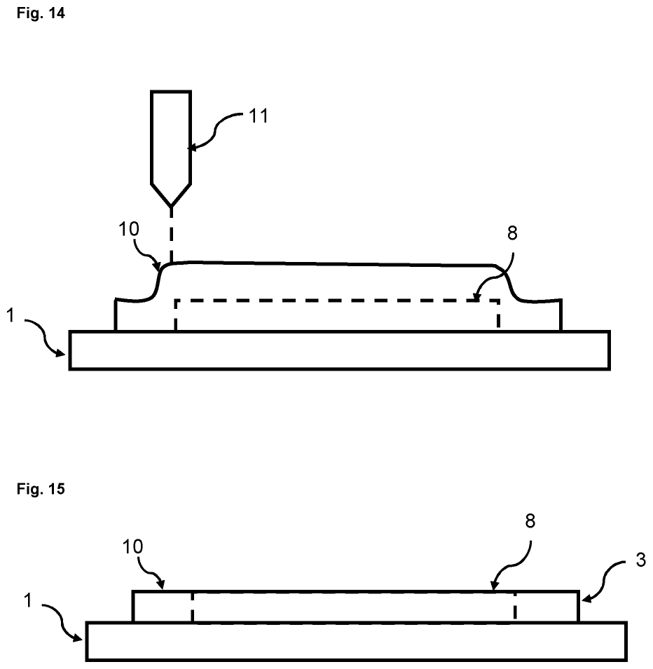

FIG. 14 shows the same master plate laterally, where a laser cutting device 11 is used to separate off the portion of the compensation layer 10 above the master hologram layer 8 from the remaining part. It is thus possible to subsequently remove this part of the compensation layer 10.

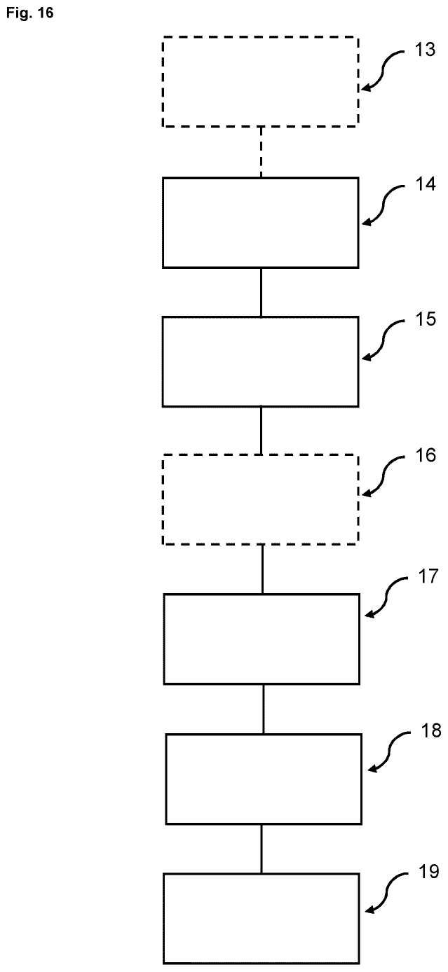

FIG. 15 shows the same master plate laterally, where the compensation layer 10 has been removed again above the master hologram layer 8. This then results in the first homogeneous layer 3.

FIG. 16 once again shows the preferred steps of the production process.

Step 14: The applying of a first layer of homogeneous thickness that comprises at least one master hologram layer on a first side of a two-dimensional thin glass pane, where an outer region at the lateral edges of the thin glass pane remains free of the first layer.

Step 15: the applying of spacer elements to the first side in the outer region.

Step 17: the applying of the thick glass pane by superimposition onto the first side of the thin glass pane with an intervening adhesive layer, where the applying of the adhesive layer may preferably also be defined as a preceding separate intermediate step 16, which was therefore only drawn in the form of dotted lines. In this case, step 17 comprises merely the applying of the thick glass pane by superimposition.

Step 18: the introducing of the two glass panes into an arrangement comprising a vacuum module and a vibration module.

Step 19: the curing of the adhesive.

Step 14 preferably implicitly comprises the providing of the thin glass pane. However, this can likewise be regarded preferably as a separate, especially first, step 13 of the production process, which is therefore only shown by dotted lines.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

### LIST OF REFERENCE SIGNS

1 two-dimensional thin glass pane
2 first side of the two-dimensional thin glass pane
3 first homogeneous layer
4 outer region that remains clear
5 spacer elements
6 thick glass pane
7 adhesive layer
8 master hologram layer
9 edge region that remains free of the master hologram
10 compensation layer
11 laser cutter
12 resultant layer when compensation layer is applied to master hologram layer
13 providing of the thin glass pane
14 applying of a first layer to a first side of the thin glass pane
15 applying of spacer elements to the first side
16 applying of the adhesive layer
17 applying of the thick glass pane, preferably with an intervening adhesive layer
18 introducing of the two glass panes into an arrangement comprising a vacuum module and a vibration module
19 curing of the adhesive

1-19. (canceled)

20. A production method for a master plate comprising a flat and two-dimensional composite pane, the production method comprising:
applying a first layer of homogeneous thickness that comprises at least one master hologram layer on a first side of a two-dimensional thin glass pane, wherein an outer region at the lateral edges of the thin glass pane remains free of the first layer, and wherein the master hologram layer is capable of having an optical function of a hologram;
applying spacer elements to the first side in the outer region, wherein the spacer elements are set up to keep the outer edges and/or lateral edges of a two-dimensional thick glass pane to be applied and of the thin glass pane at a predefined separation in the production method;
applying the thick glass pane by superimposition onto the first side of the thin glass pane with an intervening adhesive layer, wherein the thick glass pane has the same areal dimensions as the thin glass pane;
introducing the thick glass pane and the thin glass pane into an arrangement comprising a vacuum module and a vibration module, wherein the arrangement is set up for mutual contact pressure of the thick glass pane and the thin glass pane and uniform distribution of the adhesive in the desired thickness by generation of reduced pressure and vibrations; and
curing the adhesive.

21. The production of claim 20, wherein the master hologram layer is applied essentially over the full area as a liquid material.

22. The production method of claim 20, wherein the application of the first layer is preceded by first applying an optically transparent, double-sidedly adhesive film essentially to the full area of the first side of the thin glass pane, leaving at least some areas of the outer region at the lateral edges free of the film.

23. The production method of claim 20, wherein the first layer comprises the master hologram layer which is disposed in a middle region spaced apart from the lateral edges of the thin glass pane and comprises a compensation layer having the same thickness as the master hologram layer in an edge region between outer region and master hologram layer that remains free of the master hologram, wherein the compensation layer comprises a film.

24. The production method of claim 23, wherein the compensation layer and/or the optically transparent, double-sidedly adhesive film is first applied to a complete edge region and then is removed again in the outer region.

25. The production method of claim 24,
wherein the step of removing the compensation layer and/or removing the optically transparent, double-sidedly adhesive film in the outer region comprises:
severing the compensation layer and/or the optically transparent, double-sidedly adhesive film between the part to be removed and the remaining part, preferably by laser cutting,
lifting off the part of the compensation layer and/or of the optically transparent, double-sidedly adhesive film that is to be removed.

26. The production method of claim 23, wherein the compensation layer is applied after the master hologram layer, and wherein the compensation layer is removed after being applied to the master hologram layer.

27. The production method of claim 20, wherein the master hologram layer comprises a carrier film, and wherein the master hologram layer already has the optical function prior to the application.

28. The production method of claim 20, wherein the thin glass pane has a thickness at right angles to the areal extent of between 2 millimeters and 0.1 millimeter, and wherein the thick glass pane has a thickness at right angles to the areal extent of between 2 millimeters and 20 millimeters.

29. The production method of claim 20,
wherein the arrangement comprises a vacuum press having an elastic and airtight membrane cover that can be arranged above the thick glass pane and the thin glass pane, and a rest for the thick glass pane and the thin glass pane, wherein the introduction into the arrangement comprises:
applying the air-tight elastic membrane cover to the thick glass pane and the thin glass pane and the rest, so as to form a closed cavity between the rest and membrane cover that encloses the thick glass pane and the thin glass pane; and
generating the reduced pressure within the cavity with an air pressure of less than 100 mbar such that the thick glass pane is pressed onto the thin glass pane by the membrane and the adhesive is distributed uniformly.

30. The production method of claim 20, wherein the reduced pressure is switched on at a time between a tenth of the pot life of the adhesive and a quarter of the pot life of the adhesive and is switched off on attainment of the pot life of the adhesive.

31. The production method of claim 20, wherein the vibrations have a frequency between 50 Hz and 20 kHz and are varied over time, wherein the vibrations are employed until the adhesive has cured.

32. The production method of claim 20, further comprising exposing of the optical function onto the master hologram layer after the adhesive has cured.

33. The production method of claim 20, wherein the master hologram layer comprises a photopolymer.

34. A master plate produced via the production method of claim 20.

35. A master plate for industrial hologram replication, comprising
a flat and two-dimensional composite pane, comprising:
a thick glass pane as a carrier for minimization of bending of the master plate; and
a thin glass pane for protection of a master hologram layer from mechanical influences; and
at least one master hologram layer disposed between the thick glass pane and the thin glass pane, which includes the optical function of a hologram,
wherein the thick glass pane has a thickness at right angles to the areal extent of greater than 2 millimeters, and
wherein the thin glass pane has a thickness at right angles to the areal extent of between 2 millimeters and 0.1 millimeter.

36. The master plate of claim 35, wherein the master hologram layer has a thickness between 1 μm and 200 μm.

37. The master plate of claim 35, wherein the composite pane further comprises a transparent, double-sidedly adhesive film, a carrier film for the master hologram layer and/or at least one layer of an adhesive.

38. The master plate of claim 37, wherein the thickness of the adhesive layer is between 10 μm and 500 μm.
